(19) United States
(12) Patent Application Publication
(10) Pub. No.: US 2017/0287362 A1
(43) Pub. Date: Oct. 5, 2017

(54) BODY CAVITY SIMULATOR FOR DETECTING A SIMULATED MEDICAL INSTRUMENT

(71) Applicant: CAE HEALTHCARE CANADA INC, Saint-Laurent (CA)

(72) Inventor: François CARON, Saint-Laurent (CA)

(21) Appl. No.: 15/085,212

(22) Filed: Mar. 30, 2016

(51) Int. Cl. G09B 23/28; G09B 5/02

(52) U.S. Cl. CPC G09B 23/285; G09B 5/02

(57) ABSTRACT

The present disclosure relates to a body cavity simulator. The body cavity simulator is adapted for simulating medical instrument insertion procedures. The body cavity simulator comprises a duct, a plurality of haptic mechanisms and a plurality of sensors. The duct defines an insertion path adapted for receiving and guiding translation of a simulated medical instrument. Each haptic mechanism is positioned at a haptic point along the insertion path. Each haptic mechanism is adapted for applying a resistive haptic force to the simulated medical instrument. Each sensor is co-located with one of the haptic mechanisms. Each sensor is adapted for detecting the simulated medical instrument at the haptic point and generating simulated medical instrument positioning data.

### TECHNICAL FIELD

The present disclosure generally relates to the field of medical simulation for healthcare training. More specifically, the present disclosure relates to a body cavity simulator for sensing a simulated medical instrument and simulating medical instrument insertion procedures.

### BACKGROUND

Medical simulations are used to practice complex medical procedures, for training medical professionals and/or rehearsing a particular medical procedure in a simulation environment before performing particular medical procedure on a real patient.

A specific type of complex medical procedure consists in inserting a medical instrument (e.g. a guide wire, a catheter, a cannula, etc.) inside a body channel (e.g. in a trachea while performing a tracheotomy, in a channel of the intestine such as the large intestine or the small intestine while performing an intervention on the digestion system, etc.). The medical procedure may involve insertion of a single medical instrument in the channel. Alternatively, a more complex medical procedure may involve insertion of a plurality of medical instruments in the channel (e.g. a guide wire inserted inside a catheter inserted inside a cannula inserted inside the channel).

Devices for simulating medical insertion procedures involving mock medical instruments have been developed for practicing the medical instrument insertion procedures. The device simulates a particular body region, for instance a body cavity comprising a channel, and allows insertion of the mock medical instrument(s) inside the simulated body region. Some of these devices further include a dedicated mechanism for tracking the progress of the mock medical instrument(s) inside the simulated body region.

However, such devices are usually bulky, and their size reduces their mobility.

Moreover, such devices are usually specially designed for a specific simulation application and cannot be used to realistically simulate distinct various medical procedures while providing satisfactory dynamic haptic interactions.

There is therefore a need for a new body cavity simulator for simulating medical procedures that would reduce at least one of the above mentioned drawbacks of known simulation systems.

### SUMMARY

It is an object of the present disclosure to obviate or mitigate at least one disadvantage of previous body cavity simulators for simulating medical instrument insertion related medical procedures.

The present body cavity simulator is adapted for simulating medical instrument insertion procedures. The body cavity simulator comprises a duct, a plurality of haptic mechanisms and a plurality of sensors. The duct defines an insertion path adapted for receiving and guiding translation of a simulated medical instrument. Each haptic mechanism is positioned at a haptic point along the insertion path, each haptic mechanism is adapted for applying a resistive haptic force to the simulated medical instrument. Each sensor is co-located with one of the haptic mechanisms. Each sensor is adapted for detecting the simulated medical instrument at the haptic point and generating simulated medical instrument positioning data.

### BRIEF DESCRIPTION OF THE DRAWINGS

Embodiments of the disclosure will be described by way of example only with reference to the accompanying drawings, in which:

FIG. 1 is a schematic cross-sectional view of a section of a body cavity simulator for simulating medical instrument insertion procedures using sensors; and

FIG. 2 is a schematic view a control unit.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems of simulating medical instrument insertion procedures requiring insertion of one or more medical instruments into an anatomical structure of a patient such as veins, arteries, trachea, intestine or any other tubular anatomical structures. The various aspects described herein are particularly well suited for training medical professionals to perform such medical instrument insertion procedures.

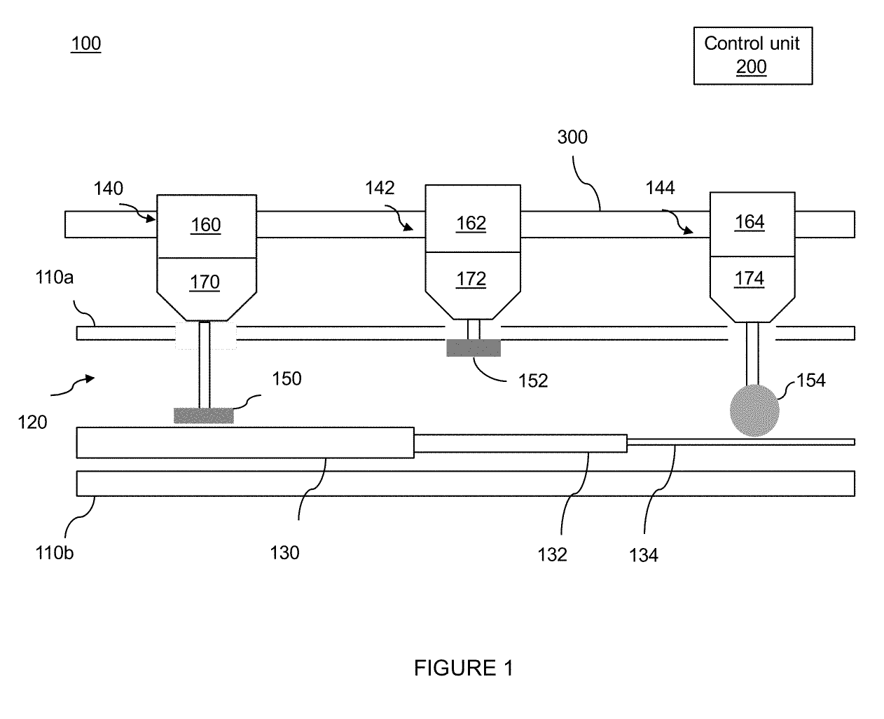

Referring to FIG. 1, there is shown a schematic cross-sectional perspective view of a section of a body cavity simulator 100 for simulating medical instrument insertion procedures. The body cavity simulator 100 is intended to be used with one or several simulated medical instruments, either being used independently or concurrently. The body cavity simulator 100 provides dynamic haptic interactions to the user inserting the medical instrument(s) so as to realistically simulate insertion of the medical instrument in a patient's anatomical structure.

The body cavity simulator 100 comprises a duct 110. As FIG. 1 is a schematic cross-section view of a section of the body cavity simulator 100, the duct 110 is shown as two distinct parts 110a and 110b, but in reality the duct may be one single component defining an insertion path 120. The duct 110 may have any shape and size suitable for allowing simulation of medical instrument insertion procedures in the insertion path 120. The duct 110 could have an even shape, or an uneven shape as shown on FIG. 1 where the upper section of the duct 110a is thinner than the lower section of the duct 110b which is larger. The duct 110 could be made of a single material, or composed of various materials. For example, a portion of the duct 110a could be made of a translucent or transparent material, while the other portion of the duct 110b could be made of an opaque material. The duct 110 could be made of any of the following: a rigid material, a semi-rigid material, a flexible material, a shape memory material or any combination thereof. The duct 110 can be straight, slightly bended, semi-circular or circular. Although not shown on FIG. 1, the body cavity simulator 100 could be composed of several consecutive ducts 110 connected to one another so as to define a continuous insertion path 120. Furthermore, the duct 110 could be composed of telescopic ducts sections (not shown) which may be expanded or collapsed depending on the anatomical structure to be simulated.

The insertion path 120 simulates an anatomical structure, such as a trachea, an artery, an intestine, etc. The insertion path 120 can be shaped to avoid dead points. The insertion path 120 may have a circular cross-section or another shape based on the type of anatomical structure to be simulated. Moreover, the diameter and length of the insertion path 120 may change as a function of the anatomical structure to be simulated. The insertion path 120 receives and guides translation of simulated medical instrument(s) 130, 132 and 134. The insertion path 120 may be any of the following: smooth, grooved, uneven, provided with obstacles, or a combination thereof. FIG. 1 shows a smooth insertion path for simplicity purposes only.

Three simulated medical instruments 130, 132 and 134 are shown on FIG. 1 to schematically demonstrate various aspects of the present body cavity simulator 100. However, the present body cavity simulator 100 could receive only one of the simulated medical instruments 130, 132 and 134, two of the simulated medical instruments 130, 132 and 134 or more than three simulated medical instruments. The number of simulated medical instruments and the configuration of the simulated medical instruments 130, 132 and 134 depend on the medical instrument insertion procedure to be simulated. The simulated medical instruments 130, 134 and 134 could be any of the following: a mock-up medical instrument, a medical instrument modified for simulation purposes, or a medical instrument not modified.

The body cavity simulator 100 also comprises a plurality of haptic mechanisms 140, 142 and 144. Each haptic mechanism 140, 142 and 144 is adapted for applying a resistive haptic force to one or several of the simulated medical instruments 130, 132 and 134. Each haptic mechanism 140, 142 and 144 is located at a haptic point 150, 152 and 154 of the duct along the insertion path 120. FIG. 1 schematically depicts three haptic mechanisms 140, 142 and 144 and three haptic points 150, 152 and 154. However, the present body cavity simulator 100 is not limited to such a number of haptic mechanisms and haptic points. The present body cavity simulator 100 could include fewer haptic points and haptic mechanisms or more haptic points and haptic mechanisms.

The haptic mechanisms 140, 142 and 144 are mounted along the duct 110. Each haptic mechanism 140, 142 and 144 comprises an actuator 160, 162, 164. Each actuator 160, 162 and 164 pushes a corresponding haptic point 150, 152 and 154 towards the simulated medical instruments 130, 132 and/or 134, for restraining the insertion path 120 at the haptic point 150, 152 or 154. The reduced or restrained duct 110 at each haptic point 150, 152 and 154 causes a friction against the simulated medical instruments. More precisely, with respect to FIG. 1, the haptic point 154 causes friction against the simulated medical instrument 134, the haptic point 152 is not actuated and does not cause friction at the haptic point 152, while the haptic point 150 is actuated by the actuator 160 and causes friction against the simulated medial instrument 130.

Applying friction at the haptic points 150, 152 and 154 increases realism of the medical instrument insertion simulation. Each haptic point 150, 152 and 154 corresponds to a section of the duct 110 which can be pushed so as to reduce the insertion path 120 at the haptic point. The haptic points 150, 152 and 154 are shown on FIG. 1 as sections of the duct 110 which may be displaced. However, the haptic points 150, 152 and 154 could alternatively consists of sections of the duct 110 which can be pushed and deformed so as to reduce the insertion path 120 at the haptic point. Although shown as rectangles and a sphere on FIG. 1, the haptic points 150, 152 and 154 are shaped and sized to modify the insertion path so as to correspond to an anatomical structure of a patient to be simulated.

The haptic points 150, 152 and 154 could be made of the same material as the duct 110, or could be made of another type of material better suited for generating the friction desired on the simulated medical instrument at the haptic point 150, 152 and 154.

To ensure flexibility and simulation of various anatomical structures, each haptic mechanism 140, 142 and 144 is independently controlled.

The actuators 160, 162 and 164 may be implemented using any of the following: a motor, a piston, a spring arrangement, a bladder, or any other mechanical, electrical or pneumatical device capable of exerting a pressure to the corresponding haptic point.

In the case where the duct 110 is flexible, the actuators 160, 162 and 164 may push the duct at the haptic point so as to modify the shape of the insertion path at the haptic point.

The haptic point 150, 152 and 154 may further be complemented with a brush, a bladder, a fabric, a material, a paint, etc., for providing different haptic feedback at the haptic point.

The body cavity simulator 100 is also provided with a plurality of sensors 170, 172 and 174. Each sensor 170, 172 and 174 is co-located with one of the haptic mechanisms 140, 142 and 144, and thus positioned at a corresponding haptic point 150, 152 and 154. The sensors 170, 172 and 174 are thus also co-located with the haptic points 150, 152 and 154.

The sensors 170, 172 and 174 detect and/or capture the simulated medical instrument at the haptic point and provide corresponding positioning data. The sensors 170, 172 and 174 may further detect or capture orientation of the simulated medical instrument at the corresponding haptic point 150, 152 and 154, which may also be part of the positioning data generated by the sensors 170, 172 and 174.

Various types of sensors 170, 172, 174 may be used with the present body cavity simulator 100: mechanical sensors, contact sensors, magnetic sensors, electromechanical sensors, ultrasound sensors, optical sensors, cameras, microscopes, or any combination thereof. One or several types of sensors may be used concurrently at some or all of the haptic points 150, 152 and 154 so as to concurrently capture images and detect position of the simulated medical instruments 130, 132 and/or 134 at the haptic point 150, 152 and/or 154.

Examples of mechanical sensors include: mechanical limit switches, inductive limit switches, rotary cam switches, and any other type of mechanical device which can mechanically detect when one or several of the simulated medical instruments 130, 132 and/or 134 have passed or are in the process of passing one of the haptic points 150, 152 and 154.

Examples of contact sensors include: any type of switches in which two conductors become in contact with each other, thereby completing an electrical circuit.

Examples of magnetic sensors include position magnetic sensors, MEMS sensors, etc.

Example of ultrasound sensors include any type of sensors which detect the present of one or several simulated medical instruments 130, 132 and/or 134 inside the insertion path 120 at the haptic point 150, 152 or 154.

For example, when an optical sensor is used, the optical sensor detects the presence of the simulated medical instrument 130, 132 or 134 in the vicinity of the haptic point where the optical sensor is located. When the simulated medical instrument 130, 132 and/or 134 is translated through the insertion path 120 proximate the haptic point where the optical sensor is located, the simulated medical instrument 130, 132 and/or 134 crosses an optical signal generated by an emitter of the optical sensor and a modified optical signal is received by a receptor of the optical sensor. The modified signal thus provides positioning data representative of the translation of the simulated medical instrument 130, 132 and/or 134 in the insertion path 120. The optical sensor could further scan the insertion path 120 in the vicinity of the corresponding haptic point. Detection of the specific pattern or shape defined by a specific orientation of the simulated medical instruments 130, 134 and/or 134 with respect to the optical sensor enables detection of the orientation of the simulated medical instrument.

Alternately or concurrently, one or several of the sensors 170, 172 and/or 174 consist of a camera which captures positioning data in the form of images of the simulated medical instruments 130, 132 and/or 134 in the vicinity of the haptic point 150, 152 and/or 154 where the camera is located. The images of the simulated medical instruments 130, 132 and/or 134 inside the insertion path 120 surrounding the haptic point where the camera is/are located could include the field of view of the camera. The camera may for example capture positioning data in the form of images of the simulated medical instruments 130, 132 and/or 134 inside the insertion path 120 through the duct 110 when the duct is made of a transparent or translucent material. The field of view of each camera may interlace with the field of view of other adjacent cameras located at subsequent haptic points.

The camera may be a High Definition color camera, but various other types of camera enabling detection of at least one of the position and/or orientation of the simulated medical instrument 130, 132 and/or 134 may be used. The camera may also be further provided with a magnifying optical arrangement to magnify the images captured.

One or several of the sensors 170, 172 and 174 may alternatively consist of a microscope for capturing images of the region surrounding the corresponding haptic point 150, 152 and/or 154, as previously described for the camera, but for a much smaller area of the insertion path 120 and with a much higher resolution.

The sensors 170, 172 and 174 communicate the positioning data (position and/or orientation, detected and/or captured) to a control unit to be further detailed. The sensors 170, 172 and 174 may communicate the positioning data with wires or wirelessly. The sensors 170, 172 and 174 may communicate the positioning data directly or through a network.

By combining the sensors 170, 172 and 174 with the haptic points 150, 152 and 154, it is possible to greatly increase the quality of the positioning data detected and/or captured. Furthermore, by co-locating the haptic mechanisms 140, 142 and 144 with the sensors 170, 172 and 174 at the haptic points 150, 152 and 154, it becomes possible to quickly reconfigure the body cavity simulator 100 as the haptic mechanisms 140, 142 and 144 are co-located with the sensors 170, 172 and 174 respectively at the haptic points 150, 152 and 154.

To allow simple reconfiguration of the body cavity simulator 100, the body cavity simulator is further provided with a displacement mechanism 300 which allows moving and repositioning the haptic points 150, 152 and 154, i.e. the co-located haptic mechanisms 140, 142 and 144 and corresponding sensors 170, 172 and 174 respectively, along the insertion path 120 of the duct 110. The displacement mechanism 300 may consist of a structure extending along the duct 110 such as a rail on which the haptic mechanisms 140, 142 and 144 and co-located sensors 170, 172 and 174 respectively, are slidably mounted. Any other means or structure enabling a controlled positioning of the haptic mechanisms 140, 142 and 144 and co-located sensors 170, 172 and 174 respectively, at various positions along the duct 110 may be considered. As it should be apparent, the position of the various haptic points 150, 152 and 154 along the duct 110 may thus be configured to simulate a particular anatomical structure and the corresponding haptic points.

For greater flexibility, the duct 110 may be provided with a series of consecutive haptic points 150, 152 and 154, to which the haptic mechanisms 140, 142 and 144 may align with based on the anatomical structure to be simulated. Alternatively, the duct 110 may be provided with a series of apertures (not shown), where the haptic points 150, 152 and 154, haptic mechanisms 140, 142 and 144 and co-located sensors 170, 172 and 174 may be positioned. The haptic mechanisms 140, 142 and 144 and the co-located sensors 170, 172 and 174 may be positioned along the displacement mechanism 300 manually, or by use of motors controlled by a processor such as by a control unit 200, based on the anatomical structure selected for simulation by the body cavity simulator 100.

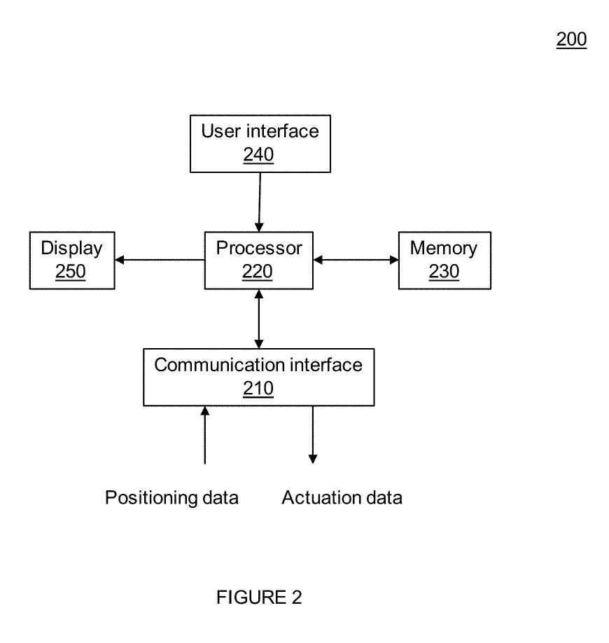

Reference is now concurrently made to FIGS. 1 and 2, where FIG. 2 is a schematic view of the control unit 200.

The control unit 200 receives the positioning data from each of the sensors 170, 172 and 174 of the body cavity simulator 100. The positioning data provides an identification of the sensor 170, 172 and 174 and/or of the corresponding haptic point 150, 152 and 154. The positioning data comprises for each sensor and/or haptic point, a position of the simulated medical instrument at the corresponding haptic point 150, 152 and 154. The positioning data may also comprise an orientation of the simulated medical instrument (130, 132 or 134) at the corresponding haptic point 150, 152 and 154. To facilitate detection position and/or orientation of the simulated medical instrument at the haptic points 150, 152 and 154, the simulated medical instruments 130, 132 and 134 may be provided with a tracking device (not shown) which can be detected by the sensors 170, 172 and 174 to determine the identification of the simulated medical instrument, the position of a distal end of the simulated medical instrument, and the orientation of the simulated medical instrument equipped with such a tracking device. Examples of such tracking devices include without limitations: a pattern of colors at a distal end of the simulated medical instrument, a flag attached at or near a distal end of the simulated medical instrument, a bar code applied near a distal end of the medical instrument, a particular shape affixed to a distal end of the simulated medical instrument, or any other type of device which may be used and recognized by the sensors 170, 172 and 174 to determine the identification of the simulated medical instrument, the position of the simulated medical instrument and/or the orientation of the simulated medical instrument in the insertion path 120.

The control unit 200 may be implemented as a separate unit from the body cavity simulator 100, or be incorporated therein. For example, the control unit 200 may be a separate electronic device such as a computer, a tablet, a smart phone, or a remote electronic device accessible through a wireless network.

The control unit 200 comprises a communication interface 210 for receiving the positioning data from the sensors 170, 172 and 174. The communication interface 210 may support any communication protocol (e.g. USB, Wi-Fi, cellular, etc.) adapted for receiving positioning data captured by the sensors 170, 172 and 174. The communication interface 210 further supports sending actuating signals to the haptic mechanisms 140, 142 and 144.

The control unit 200 further comprises a processor 220 for processing the received positioning data from the sensors 170, 172 and 174 through the communication interface 210. The positioning data comprises an identification of the sensor 170, 172 or 174, or an identification of the corresponding haptic point 150, 152 or 154. The positioning data further comprises position data of the simulated medical instrument at the corresponding haptic point 150, 152 or 154. Examples of positioning data and how the processor 220 processes the positioning data will be discussed further.

The processor 220 also receives through a user interface 240 configuration and/or particular training configurations to be implemented by the body cavity simulator 100. For example, the user interface 240 allows a user of the control unit 200 to select a body cavity model corresponding to a specific anatomical structure of a patient to be simulated by the body cavity simulator 100. Several body cavity models may be stored in memory 230, each corresponding to a specific anatomical structure. Many body cavity models may be stored for a single anatomical structure, each body cavity model corresponding to a particular condition present in the corresponding anatomical structure.

Each body cavity model stored in memory 230 comprises a position for the haptic points 150, 152 and 154 to be actuated in the body cavity simulator 100 during a medical instrument insertion simulation. The memory 230 further stores for each haptic point 150, 152 and 154 to be actuated in the body cavity simulator 100 the conditions to be met for actuating the corresponding haptic mechanisms 140, 142 and 144. Furthermore, the memory 230 stores the type of actuation of each haptic mechanism 140, 142 and 144, such as for example: partial actuation, complete actuation, and no actuation. The memory 230 further stores instructions of the computer program(s) executed by the processor 220, data generated by the execution of the computer program(s), positioning data received via the communication interface 210, etc. The memory 230 may also store a database of body cavity models and results of simulations performed. The memory 230 may comprise several types of memories, including volatile memory, non-volatile memory, etc., co-located with the processor 220 or remotely located from the processor 220 and accessible to a network.

The control unit 200 further comprises a display 250. The display 250 is used when configuring the body cavity simulator 100 and during a simulation for displaying progress of the insertion of the simulated medical instruments 130, 132 and 134 in the insertion path 120 of the body cavity simulator 100. A user of the control unit 200 can configure the body cavity simulator 100 to simulate a particular anatomical structure by selecting on the display 250 a corresponding body cavity model stored in memory 230 through the user interface 240. Progress of the insertion of the simulated medical instruments 130, 132 and 134 can be superposed to an image of the corresponding anatomical structure, and displayed on the display 250 so as to increase realism of the simulation. The communication interface 210, the processor 220, the memory 230, the user interface 240 and the display 250 may correspond to the communication interface, the processor, the memory, the user interface and the display of the electronic device on which a computer program including instructions code is being executed thereon.

The processor 220 of the control unit 200 analyzes the positioning data (detected and/or capture) received from the sensors 170, 172 and 174, based on the body cavity model and configuration selected by the user. The analysis comprises determining at least one of the following: an identification of at least one simulated medical instrument detected and/or captured at one of the haptic points, a translation movement of the at least one simulated medical instrument detected and/or captured at one of the haptic points, and an orientation of the at least one simulated medical instrument detected and/or captured at one of the haptic points.

For example, when the positioning data includes captured images by a camera, analyzing the captured images may include determining presence and position of visual marks of each simulated medical instruments 130, 132 and/or 134 inside the insertion path 120. Based on the particular geometry of the insertion path at some of the haptic points 150, 152 and/or 154, a translation movement for each simulated medical instrument 130, 132 and/or 134 can be further determined.

The processor 220 of the control unit 200 may further automatically instruct every haptic mechanism to await until presence of one of the simulated medical instruments 130, 132 and/or 134 is detected in the vicinity of the corresponding haptic point 150, 152 and/or 154 before actuating the corresponding co-located haptic mechanism 140, 142 and/or 144.

Alternatively, the processor 220 of the control unit 200 may await the receipt of positioning data indicative of an improper medical instrument insertion in the insertion path 120 before actuating one or several of the haptic mechanisms 140, 142 and/or 144. For example, the processor 220 may actuate one or several of the haptic mechanisms 140, 142 and/or 144 when one or several simulated medical instruments 130, 132 and/or 134 are improperly inserted (position, translation movement and/or orientation) within the insertion path 120 based on the selected body cavity model.

Although the present body cavity simulator has been described hereinabove by way of non-restrictive, illustrative embodiments thereof, these embodiments may be modified at will within the scope of the appended claims without departing from the spirit and nature of the present disclosure.

1. A body cavity simulator for simulating medical instrument insertion procedures, the simulator comprising:
a duct consisting of a single component defining an insertion path inside the duct, the insertion path being adapted for receiving and guiding translation of a simulated medical instrument;
a plurality of haptic mechanisms, each haptic mechanism being positioned at a haptic point along the insertion path defined inside the duct, each haptic mechanism applying a resistive haptic force to the simulated medical instrument; and
a plurality of sensors, each sensor being co-located with one of the haptic mechanisms, each sensor being adapted for detecting the simulated medical instrument at the haptic point and for generating simulated medical instrument positioning data.

2. The body cavity simulator of claim 1, further comprising a control unit for controlling the plurality of haptic mechanisms.

3. The body cavity simulator of claim 1, wherein the insertion path is further adapted for receiving at least one additional simulated medical instrument sliding in the other simulated medical instrument along the insertion path.

4. The body cavity simulator of claim 1, wherein at least one of the haptic mechanisms is adapted for constricting the insertion path.

5. The body cavity simulator of claim 4, wherein each of the haptic mechanisms comprises one of an actuator, a motor, a piston, a bladder, a spring arrangement or any combination thereof.

6. The body cavity simulator of claim 1, wherein at least one haptic mechanism is provided with a displacement mechanism for moving the at least one haptic mechanism along the insertion path.

7. The body cavity simulator of claim 6, wherein the displacement mechanism comprises a structure extending along the duct.

8. The body cavity simulator of claim 1, wherein each of the sensors comprises one of a magnetic sensor, a radar device, a contact sensor, a mechanical sensor or any combination thereof.

9. The body cavity simulator of claim 1, wherein the positioning data comprises a position and orientation of the simulated medical instrument.

10. A medical instrument insertion simulator comprising:
the body cavity simulator of claim 1 for simulating medical instrument insertion procedures;
at least one simulated medical instrument;
a control unit for controlling the haptic mechanisms by receiving the positioning data, the control unit determining the resistive haptic force to apply to the simulated medical instrument by the haptic mechanisms according to the positioning data, the control unit further producing a visual display image of the position and orientation of the simulated medical instrument; and
a display unit for displaying the visual display image.

11. The medical instrument insertion simulator of claim 10, wherein the control unit activates the haptic mechanisms upon detection of a predetermined
